(19) United States
(12) Patent Application Publication
(10) Pub. No.: US 2025/0276911 A1
(43) Pub. Date: Sep. 4, 2025

(54) POSITIVE ELECTRODE ACTIVE MATERIAL AND METHOD FOR RECYCLING POSITIVE ELECTRODE ACTIVE MATERIAL

(71) Applicant: LG Energy Solution, Ltd., Seoul (KR)

(72) Inventors: Jeong Mi CHOI, Daejeon (KR); Se Ho Park, Daejeon (KR); Jeongbae Lee, Daejeon (KR); Yeon Jun Kim, Daejeon (KR); Yongsik Seo, Daejeon (KR); Gwangseon Park, Daejeon (KR)

(21) Appl. No.: 19/065,758

(22) Filed: Feb. 27, 2025

(30) Foreign Application Priority Data
Feb. 29, 2024 (KR) 10-2024-0029795
Jan. 13, 2025 (KR) 10-2025-0004743

(51) Int. Cl. C01G 53/502; H01M 10/54

(52) U.S. Cl. CPC C01G 53/502; H01M 10/54; C01P 2002/60; C01P 2002/70; C01P 2004/84; C01P 2006/40

(57) ABSTRACT

The present disclosure relates to a positive electrode active material and a recycling method thereof. In the positive electrode active material and a recycling method thereof, the positive electrode active material is at least one type selected from a lithium nickel oxide (LNO)-based positive electrode active material, a nickel-cobalt-manganese (NCM)-based positive electrode active material, a nickel-cobalt-aluminum (NCA)-based positive electrode active material and a nickel-cobalt-manganese-aluminum (NCMA)-based positive electrode active material, in which single particles are included, a content of F is about 5,700 mg/kg to 6,500 mg/kg, an a-axis lattice parameter measured by an XRD analysis is about 2.8753 Å to 2.8772 Å, a c-axis lattice parameter is about 14.243 Å to 14.255 Å, a cell volume is about 101.968 Å³ to 102.168 Å³ and a crystallite size is greater than about 130 nm and equal to or less than 136 nm.

### CROSS-REFERENCE TO RELATED APPLICATIONS

This application is based on and claims priority from Korean Patent Application No. 10-2024-0029795, filed on Feb. 29, 2024, and Korean Patent Application No. 10-2025-0004743, filed on Jan. 13, 2025, with the Korean Intellectual Property Office, the disclosure of which is incorporated herein in its entirety by reference.

### TECHNICAL FIELD

The present disclosure relates to a positive electrode active material and a recycling method thereof.

### BACKGROUND

A lithium secondary battery is largely composed of a positive electrode having a positive electrode active material layer coated on metal foil such as aluminum, a negative electrode having a negative electrode active material layer coated on metal foil such as copper, a separator that prevents the positive electrode and the negative electrode from mixing with each other, and an electrolyte through which lithium ions are allowed to move between the positive electrode and the negative electrode.

The positive electrode active material layer mainly uses lithium-based oxide as an active material, and the negative electrode active material layer mainly uses carbon material as an active material. A lithium cobalt oxide (LiCoO₂), a lithium nickel oxide (LiNiO₂), a lithium manganese oxide (LiMnO₂ or LiMnO₄), a lithium iron phosphate compound (LiFePO₄), and the like, are used for the lithium-based oxide.

### SUMMARY

The present disclosure provides a method of recycling a positive electrode active material containing single particles. In recycling a positive electrode active material excellent in the charging capacity, resistance characteristics and capacity characteristics, the method is environmentally friendly because acid is not used in the recovery and recycling process, and thus a neutralization and wastewater treatment is not required, thereby reducing a process cost. Since the positive electrode active material is recycled without decomposition, there are no waste metal elements, and since no organic solvent is used, there is no generation of toxic gas or risk of explosion. Then, since the pre-washing process is omitted, the economic efficiency and productivity are greatly improved.

In the positive electrode active material recycling method of the present disclosure, the single-particle-containing positive electrode active material recovered after heat treatment of a waste positive electrode is not subjected to a pre-washing process and is directly annealed through the addition of a lithium precursor and then is subjected to surface-coating. Since the positive electrode active material is milled before and/or after the annealing, fluorine (F) is included in a predetermined amount on the surface of the positive electrode active material, and the crystal structure and crystallite size of the positive electrode active material analyzed by X-ray diffraction (XRD) are adjusted to fall within predetermined ranges.

Also, the present disclosure provides a secondary battery excellent in the initial discharging capacity and capacity characteristics by using the positive electrode active material recycling method.

In order to achieve the above object, I) the present disclosure provides a positive electrode active material comprising at least one type selected from a lithium nickel oxide (LNO)-based positive electrode active material, a nickel-cobalt-manganese (NCM)-based positive electrode active material, a nickel-cobalt-aluminum (NCA)-based positive electrode active material and a nickel-cobalt-manganese-aluminum (NCMA)-based positive electrode active material, wherein the positive electrode active material contains single particles, the content of F is about 5,700 mg/kg to 6,500 mg/kg, and/or an a-axis lattice parameter of the positive electrode active material measured by an XRD analysis is about 2.8753 Å to 2.8772 Å, a c-axis lattice parameter of the positive electrode active material is about 14.243 Å to 14.255 Å, a cell volume of the positive electrode active material is about 101.968 Å³ to 102.168 Å³ and a crystallite size of the positive electrode active material is greater than about 130 nm and equal to or less than 136 nm.
II) in I), the positive electrode active material may contain 40 mol % or more of Ni based on 100 mol % of all remaining metals excluding Li.
III) in I) or II), the positive electrode active material may have a surface coated with a coating agent containing metal or carbon.
IV) in I) to III), the positive electrode active material may be a recycled positive electrode active material.

Also, V) the present disclosure provides a positive electrode active material recycling method comprising the steps of: (a) performing heat treatment of a waste positive electrode having a positive electrode active material layer formed on a current collector at about 300° C. to 650° C. so as to thermally decompose a binder and a conductive material in the positive electrode active material layer and to recover a single-particle-containing positive electrode active material in the positive electrode active material layer; (b) adding a lithium precursor to the recovered positive electrode active material and annealing the positive electrode active material at about 400° C. to 1,000° C.; (c) washing the annealed positive electrode active material with a washing solution; and (d) performing surface-coating of the washed positive electrode active material, in which the positive electrode active material recycling method includes: the step of performing milling before the recovered positive electrode active material is annealed in the step (b); and/or the step of performing milling before the annealed positive electrode active material is washed in the step (c), or a positive electrode active material recycling method comprising the steps of: (a) performing heat treatment of a waste positive electrode having a mid-nickel positive electrode active material layer formed on a current collector at about 300° C. to 650° C. so as to thermally decompose a binder and a conductive material in the positive electrode active material layer and to recover a single-particle-containing positive electrode active material in the positive electrode active material layer; (b) adding a lithium precursor to the recovered positive electrode active material and annealing the positive electrode active material at about 400° C. to 1,000° C.; (c) washing the annealed positive electrode active material with a washing solution; and (d) performing surface-coating of the washed positive electrode active material, in which the positive electrode active material recycling method includes: the step of performing milling before the recovered positive electrode active material is annealed in the step (b); and/or the step of performing milling before the annealed positive electrode active material is washed in the step (c).

In the description of the present disclosure, the mid-nickel positive electrode active material may mean a positive electrode active material containing 40 mol % or more of nickel, specifically, 40 to 70 mol % based on 100 mol % of all metals excluding lithium, i.e., 100 mol % of all transition metals.

In the description of the present disclosure, the milling step prior to annealing means that milling is performed before the lithium precursor is added to the positive electrode active material recovered after the heat treatment of the waste positive electrode.
VI) in I) to V), the positive electrode active material may be at least one type selected from a LNO-based positive electrode active material, a NCM-based positive electrode active material, a NCA-based positive electrode active material, and a NCMA-based positive electrode active material, and contain 40 mol % or more of Ni based on 100 mol % of all remaining metals excluding Li.
VII) in V) to VI), the milling may be carried out by using a centrifugal mill, a jet mill, or a pin mill.
VIII) in V) to VII), the milling may be carried out at about 6,000 rpm to 18,000 rpm.
IX) in V) to VIII), the lithium precursor may contain at least one of LiOH, Li₂CO₃, LiNO₃, and Li₂O.
X) in V) to IX), in the step (b), the lithium precursor may be added at least in an amount reduced from a molar ratio of lithium in the positive electrode active material in the step (a) on the basis of the amount of lithium in the recovered positive electrode active material.
XI) in V) to X), in the washing in the step (c), a weight ratio of the annealed positive electrode active material or the milled positive electrode active material to the washing solution may be about 1:0.5 to 1:5.5.
XII) in V) to XI), the step (c) may include the step of mixing the annealed positive electrode active material or the milled positive electrode active material with the washing solution and performing filtration; and the step of drying a solid positive electrode active material obtained after the filtration.
XIII) in V) to XII), in the surface-coating of the step (d), a surface may be coated with at least one type of a metal, an organic metal, and a carbon component in a solid or liquid manner and then heat treatment may be performed at about 100° C. to 1,200° C.

Also, XIV) the present disclosure provides a secondary battery that characteristically includes the positive electrode active material of any one of I) to IV).

According to the present disclosure, the single-particle-containing positive electrode active material recovered after heat treatment of a waste positive electrode is not subjected to a pre-washing process and is directly annealed through the addition of a lithium precursor and then is subjected to surface-coating. Since the positive electrode active material is milled before and/or after the annealing, fluorine (F) is included in a predetermined amount on the surface of the positive electrode active material, and the crystal structure and crystallite size of the positive electrode active material analyzed by an XRD analysis are adjusted to fall within predetermined ranges. There is an effect of providing a positive electrode active material excellent in charging capacity, resistance characteristics and capacity characteristics.

Also, the single-particle positive electrode active material is easily recycled directly from a waste positive electrode without deterioration of battery performance. The method is environmentally friendly because acid is not used in the recovery and recycling process of the positive electrode active material, and thus a neutralization and wastewater treatment is not required, thereby reducing the process cost. Since the positive electrode active material is recycled as it is without decomposition, there are no waste metal elements, and then since no organic solvent is used, there is no generation of toxic gas or risk of explosion. Then, since a pre-washing process is omitted, there is an effect of providing a positive electrode active material recycling method with greatly improved economic efficiency and productivity.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a view illustrating a positive electrode scrap that is to be discarded after electrode plates are cut out of a positive electrode sheet.

FIG. 2 is a graph of capacity retention rates measured for recycled or new positive electrode active materials manufactured or prepared in Examples 1 to 3, and Comparative Examples 1 to 5.

FIG. 3 is a flowchart of a recycling process of a positive electrode active material containing single particles according to the present disclosure.

### DETAILED DESCRIPTION

The present disclosure provides a direct recycled method in which a positive electrode active material containing single particles is directly recycled from a waste positive electrode into a positive electrode active material having excellent output performance (rate performance) without being decomposed. In the positive electrode active material recycling method according to one embodiment of the present disclosure, the single-particle positive electrode active material recovered by heat treatment of a waste positive electrode is directly added with a lithium precursor and is annealed without a washing process, and, for example, milling is performed before and/or after the recovered positive electrode active material is annealed. Through this process, the recycled single-particle positive electrode active material contains fluorine in a predetermined amount, and the crystal structure and crystallite size analyzed by X-ray diffraction analysis (XRD) are adjusted to fall within predetermined ranges, thereby significantly improving the charging capacity, resistance characteristics and capacity characteristics of manufactured lithium secondary batteries.

The lithium cobalt oxide used as the positive electrode active material of the lithium secondary battery has the advantages of high operating voltages and excellent capacity characteristics, but it is difficult to commercially apply the lithium cobalt oxide to large capacity batteries because cobalt which is raw material is expensive and its supply is unstable. Also, the lithium nickel oxide has poor structural stability in some aspects, making it difficult to implement sufficient life characteristics whereas the lithium manganese oxide has excellent stability, but has a problem of poor capacity characteristics. Thus, in order to compensate for the problems of the lithium transition metal oxides, lithium composite transition metal oxides containing two or more types of transition metals have been developed, and among these, a lithium nickel cobalt manganese oxide containing nickel, cobalt, and manganese is widely used in the field of electric vehicle batteries.

Meanwhile, the lithium nickel cobalt manganese oxide is prone to particle breakage in the rolling process during the manufacturing of the positive electrode, and cracks occur inside particles in the charging/discharging process, thereby increasing the contact area with the electrolyte. Due to side reactions with the electrolyte, gas generation and active material deterioration are increased, which causes a problem of degradation of life characteristics.

In order to improve the problem, although a lithium nickel cobalt manganese oxide composed of high-strength single particles is applied to the positive electrode, the oxide is difficult to recover due to its high strength when discarded after use. Even when the oxide is recovered, there is a problem such as a reduced crystallinity. This causes a problem of degradation of battery performance when the recovered oxide is applied to the positive electrode of the lithium secondary battery.

Meanwhile, the positive electrode of the lithium secondary battery contains rare metals such as nickel, cobalt, or manganese. Thus, research is being conducted to recover and recycle rare metals from the positive electrode of the lithium secondary battery that is discarded after use or positive electrode scraps, and the like, generated in the lithium secondary battery manufacturing process (hereinafter, referred to as a ‘waste positive electrode’).

Conventional techniques of recovering rare metals, such as nickel, cobalt, and manganese, from the waste positive electrode of the lithium secondary battery mostly involve methods in which the waste positive electrode is dissolved with hydrochloric acid, sulfuric acid, or nitric acid, and then nickel, cobalt, manganese, and the like, are extracted with an organic solvent and then are used again as raw materials for synthesizing the positive electrode active material.

However, the rare metal extraction method using acid has a problem of environmental pollution, and a neutralization process and a wastewater treatment process are absolutely necessary, thereby significantly increasing the process cost. Also, the method has a disadvantage in that lithium that is the main metal of the positive electrode active material cannot be recovered.

In order to solve these shortcomings, a direct recycled method, in which a positive electrode active material is directly recycled from a waste positive electrode into a positive electrode active material without being decomposed, has recently been studied. As such methods, about four representative types are introduced, including calcination, solvent dissolution, aluminum (Al) foil dissolution, and crushing & screening.

However, in spite of a simple process, the calcination method has a disadvantage in that foreign substances that degrade the battery output performance, and the like, are generated on the surface of the recycled positive electrode active material, waste gas is generated, and energy consumption is high.

Also, through the solvent dissolution method, it is possible to obtain a recycled positive electrode active material with a relatively clean surface. However, there is a disadvantage in that the stability is poor and an expensive solvent recovery process is required because a solvent used for dissolving a binder, such as N-methyl-2-pyrrolidone (NMP), is toxic gas and has a risk of explosion.

Also, in the aluminum foil dissolution method, the process stability is good, the process cost is low, and it is easy to remove a binder. However, there is a disadvantage in that foreign substances that are difficult to remove are generated on the surface of the recycled positive electrode active material, and hydrogen gas is generated during an aluminum foil removal process, thereby causing a risk of explosion.

The crushing and screening method has the advantage of being based on the simplest process, but there is a disadvantage in that it is difficult to completely separate the current collector and the positive electrode active material, the particle size distribution of the positive electrode active material changes during a crushing process, and a binder remains, thereby deteriorating the battery characteristics of the recycled positive electrode active material.

The present disclosure provides a positive electrode active material recycling method, in which a single-particle positive electrode active material is safely recycled from a waste positive electrode containing the single-particle positive electrode active material, without waste metal elements and without deteriorating the output performance, in an environmentally friendly manner with a small number of processes and a low cost.

Hereinafter, descriptions will be made on a positive electrode active material and a recycling method thereof, according to the description of the present disclosure.

Meanwhile, terms or words used in the present specification and claims should not be limitedly construed as usual or dictionary meanings, and should be interpreted as meanings and concepts consistent with the technical idea of the present disclosure on the basis of the principle that the inventor can appropriately define the concept of the term in order to explain his/her own application in the best way. Therefore, the embodiments described in this specification and the configurations illustrated in the drawings are only examples of the present disclosure, and do not represent all of the technical ideas of the present disclosure. Thus, it should be understood that there may be various equivalents and modifications that can replace them, and that they can be arranged, replaced, combined, separated, or designed in other various configurations.

Unless otherwise defined, all technical and scientific terms used in the description of the present disclosure have the same meanings as those commonly understood by a person of ordinary skill in the technical field to which the present disclosure belongs.

### Single-Particle Positive Electrode Active Material

The positive electrode active material of the present disclosure is at least one type selected from a lithium nickel oxide (LNO)-based positive electrode active material, a nickel-cobalt-manganese (NCM)-based positive electrode active material, a nickel-cobalt-aluminum (NCA)-based positive electrode active material and a nickel-cobalt-manganese-aluminum (NCMA)-based positive electrode active material. In the positive electrode active material, single particles are included; the content of F is about 5,700 mg/kg to 6,500 mg/kg; and/or the a-axis lattice parameter measured by an XRD is about 2.8753 Å to 2.8772 Å, the c-axis lattice parameter is about 14.243 Å to 14.255 Å, the cell volume is about 101.968 Å³ to 102.168 Å³, and the crystallite size has a value greater than about 130 nm and equal to or less than 136 nm. In a case where these conditions are satisfied, when the positive electrode active material of the present disclosure is applied to a lithium secondary battery, there are effects such as excellence in charging capacity, resistance characteristics and capacity characteristics of batteries.

The positive electrode active material may contain, for example, at least one type selected from lithium cobalt oxide such as LiCoO₂ (hereinafter, referred to as ‘LCO’); lithium manganese oxide such as LiMnO₂ or LiMn₂O₄; lithium iron phosphate compounds such as LiFePO₄; lithium nickel cobalt aluminum oxide (NCA); lithium nickel oxide such as LiNiO₂; nickel manganese-based lithium composite metal oxide obtained by replacing a part of nickel (Ni) of the lithium nickel oxide with manganese (Mn); and NCM-based lithium composite transition metal oxide obtained by replacing a part of nickel (Ni) of the lithium nickel oxide with manganese (Mn) and cobalt (Co). In this case, there are effects such as excellence in electrochemical performance, resistance characteristics and capacity characteristics.

The positive electrode active material according to one embodiment may contain a compound represented by the following formula 1, and has effects such as excellence in the electrochemical performance, resistance characteristics and capacity characteristics.

LiₐNiₓMn_{y}Co_{z}M_{w}O_{2+δ} [Formula 1]

(in the above formula 1, M includes at least one type selected from B, W, Al, Ti and Mg, 1<a≤1.1, 0<x<0.95, 0<y<0.8, 0<z<1.0, 0≤w≤0.1, −0.02≤δ≤0.02, and x+y+z+w=1.)

The positive electrode active material may contain, for example, 40 mol % or more, 40 mol % to 95 mol %, 40 mol % to 70 mol % (here, the positive electrode active material may be referred to as a mid-nickel positive electrode active material), or 50 mol % to 70 mol % of Ni, based on 100 mol % of all remaining metals excluding Li. Within this range, there are effects such as excellence in initial discharging capacity, output performance, capacity characteristics, and resistance characteristics.

In the description of the present disclosure, as long as the Ni content is measured by a method using IC (Ion Chromatography), etc. commonly used in the technical field to which the present disclosure belongs, for example, the measurement may be performed using an IC-ICP (Inductively Coupled Plasma) analyzer, an IC-ICP-MS analyzer, or an IC-ICP-AEC analyzer with no particular limitation.

The positive electrode active material according to one embodiment of the present disclosure may include single particles, and does not include secondary particles. In this case, there is an effect of providing a positive electrode active material, in which there is no particle breakage during the electrode manufacturing process so that a battery performance degradation caused by fine powder does not occur, life characteristics are excellent in the high-voltage environment, the thermal stability is high, and the amount of gas generated by charging/discharging is small.

The single particle may be a single particle generally used in the technical field to which the present disclosure belongs, and may be, for example, a particle composed of 30 or fewer nodules, or may be, for example, a particle composed of 1 to 20 nodules, a particle composed of 1 to 10 nodules, a particle composed of 1 to 5 nodules, or a particle composed of one nodule. In this case, there is an effect of providing a positive electrode material, in which there is no particle breakage during the electrode manufacturing process so that a battery performance degradation caused by fine powder does not occur, life characteristics are excellent in the high-voltage environment, the thermal stability is high, and the amount of gas generated by charging/discharging is small.

In the description of the present disclosure, a nodule refers to a particle unit body that constitutes a single particle, and may refer to a single crystal having no crystalline grain boundary, or a polycrystal having no grain boundary in appearance when observed using a scanning electron microscope (SEM) or an electron backscatter diffraction (EBSD) pattern analyzer in a field of view of 5000 to 20000 times.

In the description of the present disclosure, the number of nodules means the average number of nodules of positive electrode active material particles. Here, in order to obtain the number of nodules, a positive electrode including a positive electrode active material is cut by an ion milling method and a cross-sectional image in the thickness direction of the cut positive electrode is secured by using a SEM, and then, in the cross-sectional image, at least 30 particles are selected for each of the largest-size positive electrode active material particle and the smallest-size positive electrode active material particle. Thereafter, through an SEM image analysis, the numbers of nodules may be measured from the cross-section for each positive electrode active material particle, and an arithmetic mean of these may be calculated.

The average particle diameter (D₅₀) of the single particles may be, for example, about 2 μm to 10 μm, about 2 μm to 8 μm, or about 3 μm to 6 μm.

In the description of the present disclosure, the average particle diameter (D₅₀) may be defined as a particle diameter corresponding to 50% of the volume cumulative amount in the particle size distribution (PSD). The average particle diameter (D₅₀) may be measured by using, for example, a laser diffraction method. Specifically, in the measurement method of the average particle diameter (D₅₀) of the positive electrode active material, positive electrode active material particles are dispersed in a dispersion medium, and then are introduced into a commercially available laser diffraction particle size measurement device (e.g., Microtrac MT 3000) and are irradiated with ultrasonic waves of about 28 kHz with an output of 60 W. Then, an average particle diameter (D₅₀) corresponding to 50% of the volume cumulative amount in the measuring device may be calculated.

The positive electrode active material may contain, for example, about 5,700 mg/kg to 6,500 mg/kg, about 5,800 mg/kg to 6,300 mg/kg, or about 5,800 mg/kg to 6,100 mg/kg of fluorine (F), and within this range, there are effects such as excellence in charging capacity, resistance characteristics and capacity characteristics.

In the description of the present disclosure, as long as the fluorine (F) content is measured by a method using IC, etc. commonly used in the technical field to which the present disclosure belongs, as a specific example, the measurement may be performed using an IC-ICP analyzer, an IC-ICP-MS analyzer or an IC-ICP-AEC analyzer with no particular limitation.

In the positive electrode active material, the a-axis lattice parameter measured by an XRD analysis may be, for example, about 2.8753 Å to 2.8772 Å, about 2.8760 Å to 2.8770 Å, about 2.8762 Å to 2.8768 Å, or about 2.8764 Å to 2.8768 Å. Within this range, the positive electrode active material has a smaller a-axis lattice parameter than a raw-material positive electrode active material, and thus, has a different lattice structure. In the application to a lithium secondary battery, there are effects such as excellence in the charging capacity, resistance characteristics, and capacity characteristics of batteries.

In the positive electrode active material, the c-axis lattice parameter measured by an XRD analysis may be, for example, about 14.243 Å to 14.255 Å, about 14.245 Å to 14.254 Å, about 14.247 Å to 14.254 Å, or about 14.249 Å to 14.254 Å. Within this range, the lithium concentration in the lattice is increased in the c-axis indicating a z-axis direction in a layered structure. In the application to a lithium secondary battery, there are effects such as excellence in the charging capacity, resistance characteristics, and capacity characteristics of batteries.

In the positive electrode active material, for example, the cell volume measured by an XRD analysis may be, for example, about 101.968 Å³ to 102.168 Å³, about 101.980 Å³ to 102.163 Å³, about 102.000 Å³ to 102.158 Å³, or about 102.100 Å³ to 102.153 Å³. Within this range, there are effects such as excellence in the charging capacity, resistance characteristics, and capacity characteristics.

In the positive electrode active material, for example, the crystallite size measured by an XRD analysis may be, for example, greater than about 130 nm and equal to or less than 136 nm, about 131 nm to 135 nm, or about 131 nm to 134 nm. Within this range, the crystallite size is larger than that of the secondary particles, and the ion conductivity is improved, so that there are effects such as excellence in capacity characteristics.

In the description of the present disclosure, the lattice parameter, the cell volume and the crystallite size of the positive electrode active material may be measured by an XRD analysis. For example, by indexing data measured through an XRD analysis using Cu Kα X-rays, through Rietveld refinement, the lattice parameter may be calculated, the cell volume may be calculated by the product of the a-axis lattice parameter and the c-axis lattice parameter, and the crystallite size may be calculated using the Scherrer equation for the XRD measurement data.

In the description of the present disclosure, a crystal grain (crystalline) refers to a single crystal particle unit having a regular atomic arrangement.

For example, the positive electrode active material may have a surface coated with metal or carbon. For example, in the case of metal coating, without chemical and physical changes of a recycled positive electrode active material itself, the structural stability of the positive electrode active material is improved. Then, in the application to the lithium secondary battery, electrochemical characteristics such as output performance, life characteristics, and capacity are improved. Then, also, the replacement by heterogeneous elements on the surface of the positive electrode active material causes effects such as residual lithium amount reduction and pH reduction, thereby improving the physiochemical characteristics of a battery.

The metal is, for example, at least one type selected from B, W, Al, Ti, Mg, Ni, Co, Mn, Si, Zr, Ge, Sn, Cr, Fe, V and Y, is, for example, at least one type selected from B, W, Al, Ti and Mg, is boron (B), tungsten (W) or a mixture thereof, or is tungsten (W) and boron (B). In one embodiment, the metal is tungsten boride (WB), and in this case, there is an effect of improving resistance characteristics and life characteristics.

The boron-containing coating agent may be, for example, at least one type selected from H₃BO₃, B₂O₃, C₆H₅B(OH)₂, (C₆H₅O)₃B, [CH₃(CH₂)₃O]₃B, C₁₃H₁₉BO₃, C₃H₉B₃O₆ and (C₃H₇O)₃B, or may be H₃BO₃. In this case, in the application to the lithium secondary battery, there is an effect of improving resistance characteristics and life characteristics.

The coating agent may be included, for example, in an amount of about 0.001 mol % to 0.3 mol %, about 0.01 mol % to 0.3 mol %, about 0.01 mol % to 0.15 mol %, about 0.01 mol % to 0.1 mol %, or about 0.01 mol % to 0.05 mol % with respect to 1 mol % of metal in the uncoated positive electrode active material. Within this range, there is an effect of improving the structural stability and the electrochemical performance while maintaining the properties of the single-particle positive electrode active material itself as they are.

In the coating of the surface, the surface is coated with a coating agent containing, for example, at least one type of a metal, an organic metal, and a carbon component in a solid or liquid manner, and then heat treatment is performed at 100° C. to 1,200° C. In this case, there is an effect of improving the structural stability and the electrochemical performance while maintaining the properties of the positive electrode active material itself as they are.

The positive electrode active material may be, for example, a recycled positive electrode active material. In this case, there are advantages such as excellence in economic efficiency and productivity.

### Single-Particle Positive Electrode Active Material Recycling Method

The positive electrode active material recycling method of the present disclosure includes the steps of: (a) performing heat treatment of a waste positive electrode having a positive electrode active material layer formed on a current collector at about 300° C. to 650° C. so as to thermally decompose a binder and a conductive material in the positive electrode active material layer and to recover a single-particle-containing positive electrode active material in the positive electrode active material layer; (b) adding a lithium precursor to the recovered positive electrode active material and annealing the positive electrode active material at about 400° C. to 1,000° C.; (c) washing the annealed positive electrode active material with a washing solution; and (d) performing surface-coating of the washed positive electrode active material. This method includes the step of milling before the step (b) of annealing the recovered positive electrode active material; and/or the step of milling before the step (c) of washing the annealed positive electrode active material. In this case, provided is a recycled single-particle positive electrode active material, in which fluorine (F) is included in a predetermined amount on the surface of the positive electrode active material, and the crystal structure and crystallite size of the positive electrode active material analyzed by XRD fall within predetermined ranges. Thus, in the application to a lithium secondary battery, the charging capacity, resistance characteristics, and capacity characteristics are excellent. The method is environmentally friendly because acid is not used in the recovery and recycling process, and thus neutralization and wastewater treatment are not required, thereby reducing the process cost. Since the positive electrode active material is recycled as it is without decomposition, there are no waste metal elements, and then since no organic solvent is used, there is no generation of toxic gas or risk of explosion. In particular, there is an effect of a significant improvement in economic efficiency and productivity because the single-particle positive electrode active material is easily recycled directly from the waste positive electrode without deterioration of battery performance.

In another example, the positive electrode active material recycling method of the present disclosure includes the steps of: (a) performing heat treatment of a waste positive electrode having a mid-nickel positive electrode active material layer formed on a current collector at about 300° C. to 650° C. so as to thermally decompose a binder and a conductive material in the positive electrode active material layer and to recover a single-particle-containing positive electrode active material in the positive electrode active material layer; (b) adding a lithium precursor to the recovered positive electrode active material and annealing the positive electrode active material at about 400° C. to 1,000° C.; (c) washing the annealed positive electrode active material with a washing solution; and (d) performing surface-coating of the washed positive electrode active material. The method includes the step of milling before the step (b) of annealing the recovered positive electrode active material; and/or the step of milling before the step (c) of washing the annealed positive electrode active material. In this case, provided is a recycled single-particle mid-nickel positive electrode active material, in which fluorine (F) is included in a predetermined amount on the surface of the positive electrode active material, and the crystal structure and crystallite size of the positive electrode active material analyzed by XRD fall within predetermined ranges. Thus, in the application to a lithium secondary battery, the charging capacity, resistance characteristics, and capacity characteristics are excellent. The method is environmentally friendly because acid is not used in the recovery and recycling process, and thus neutralization and wastewater treatment are not required, thereby reducing a process cost. Since the positive electrode active material is recycled as it is without decomposition, there are no waste metal elements, and then since no organic solvent is used, there is no generation of toxic gas or risk of explosion. There is an effect of a significant improvement in economic efficiency and productivity because the single-particle positive electrode active material is easily recycled directly from the waste positive electrode without deterioration of battery performance.

According to one embodiment, in the description of the present disclosure, the step of milling before annealing means milling before the lithium precursor is added to the positive electrode active material recovered after the heat treatment of the waste positive electrode. However, the milling step is not limited to this, and may also be performed after the lithium precursor is added to the positive electrode active material recovered after the heat treatment of the waste positive electrode.

Hereinafter, the positive electrode active material recycling method will be described in detail for each of the separate steps.

(a) Step of Recovering Single-Particle Positive Electrode Active Material from Waste Positive Electrode

The step (a) of recovering the single-particle positive electrode active material from the waste positive electrode, according to one embodiment of the present disclosure, may include the step of performing heat treatment of the waste positive electrode having the positive electrode active material layer formed on the current collector at about 300° C. to 650° C. so as to thermally decompose the binder and the conductive material in the positive electrode active material layer and to recover the single-particle-containing positive electrode active material in the positive electrode active material layer. The positive electrode active material recovered under these conditions has an effect such as a simple process and a clean removal of a binder, a conductive material, and a current collector.

In another example, the step (a) according to the present disclosure may include the step of performing heat treatment of the waste positive electrode having the single-particle mid-nickel positive electrode active material layer formed on the current collector at about 300° C. to 650° C. so as to thermally decompose the binder and the conductive material in the positive electrode active material layer and to recover the single-particle mid-nickel positive electrode active material in the positive electrode active material layer. The mid-nickel positive electrode active material recovered under these recovery conditions has an effect such as a simple process and a clean removal of a binder, a conductive material, and a current collector.

The waste positive electrode may be a positive electrode separated from a lithium secondary battery that is discarded after use, defective positive electrode sheets or positive electrode scraps generated in the lithium secondary battery manufacturing process, or positive electrode scraps remaining after positive electrode plates are obtained by punching the positive electrode sheet.

The positive electrode active material layer in the step (a) may include a positive electrode active material, a binder, and a conductive material.

The positive electrode active material may be, for example, at least one type selected from lithium cobalt oxide such as LiCoO₂ (hereinafter, referred to as ‘LCO’); lithium manganese oxide such as LiMnO₂ or LiMn₂O₄; lithium iron phosphate compounds such as LiFePO₄; lithium nickel cobalt aluminum oxide (NCA); lithium nickel oxide such as LiNiO₂; nickel manganese-based lithium composite metal oxide obtained by replacing a part of nickel (Ni) of the lithium nickel oxide with manganese (Mn); and NCM-based lithium composite transition metal oxide obtained by replacing a part of nickel (Ni) of the lithium nickel oxide with manganese (Mn) and cobalt (Co).

The positive electrode active material may be, for example, nickel manganese-based lithium composite metal oxide, NCM-based lithium composite transition metal oxide, or a mixture thereof, and in this case, there are effects such as excellence in reversible capacity and thermal stability.

In another example, the positive electrode active material may be a compound represented by the following formula 1.

LiₐNiₓMn_{y}Co_{z}M_{w}O_{2+δ} [Formula 1]

(in the above formula 1, M includes at least one type selected from B, W, Al, Ti, and Mg, 1<a≤1.1, 0<x<0.95, 0<y<0.8, 0<z<1.0, 0≤w≤0.1, −0.02≤δ≤0.02, and x+y+z+w=1.)

The positive electrode active material may contain, for example, about 40 mol % or more, about 40 mol % to 95 mol %, about 40 mol % to 70 mol % (here, the positive electrode active material may be referred to as a mid-nickel positive electrode active material), or about 50 mol % to 70 mol % of Ni based on 100 mol % of all remaining metals excluding Li. Within this range, in the application to a lithium secondary battery, there are effects such as excellence in the initial discharging capacity, the output performance, the capacity characteristics, and the resistance characteristics.

The positive electrode active material recovered in the step (a) may be single particles, and may not include secondary particles. In this case, there is an effect of providing a recycled positive electrode active material, in which there is no particle breakage during the electrode manufacturing process so that a battery performance degradation caused by fine powder does not occur, life characteristics are excellent in the high-voltage environment, the thermal stability is high, and the amount of gas generated by charging/discharging is small.

The average particle diameter (D₅₀) of the single particles may be about 2 μm to 10 μm, about 2 μm to 8 μm, or 3 μm to 6 μm.

In the description of the present disclosure, the average particle diameter (D₅₀) may be defined as a particle diameter corresponding to 50% of the volume cumulative amount in the particle size distribution (PSD). The average particle diameter (D₅₀) may be measured by using, for example, a laser diffraction method. For example, in the measurement method of the average particle diameter (D₅₀) of the positive electrode active material, positive electrode active material particles are dispersed in a dispersion medium, and then are introduced into a commercially available laser diffraction particle size measurement device (e.g., Microtrac MT 3000) and are irradiated with ultrasonic waves of about 28 kHz with an output of 60 W. Then, an average particle diameter (D₅₀) corresponding to 50% of the volume cumulative amount in the measuring device may be calculated.

The conductive material may be, for example, a carbon-based conductive material, or may be, for example, carbon black, CNT or a mixture thereof.

The binder may be, for example, a polymer binder, may be, for example, polyvinylidene fluoride (PVdF), acrylonitrile-butadiene rubber (NBR) or a mixture thereof, or may be polyvinylidene fluoride.

In the step (a), the temperature for the heat treatment may be, for example, about 300° C. to 650° C., or may be, for example, about 400° C. to 600° C., about 500° C. to 600° C., or about 530° C. to 580° C. Within this range, there is an advantage in that the positive electrode active material is easily separated from the current collector because the current collector is not melted, and only the binder, etc., are removed.

In the heat treatment, the temperature increase rate may be, for example, about 1° C./min to 20° C./min, or may be, for example, about 3° C./min to 10° C./min, or about 3° C./min to 7° C./min. Within this range, there is an advantage in that the heat treatment can be implemented without causing a strain on the heat treatment equipment, and thermal shock, etc. are not caused in positive electrode scraps.

The heat treatment may be performed in, for example, an air or oxygen atmosphere. According to one embodiment, the heat treatment may be performed under air, and in this case, carbon components in the binder and the conductive material react with oxygen and disappear as gases such as CO and CO₂. Thus, there is an advantage in that both the binder and the conductive material are removed.

The purity of the oxygen may be, for example, about 59% or more, or may be, for example, about 70% or more, about 80% or more, about 90% or more, or 90 to 99%. Within this range, the binder and the conductive material are removed without remaining. Then, there is an advantage in that the stability of Ni in the recycled positive electrode active material is increased.

The purity % of the oxygen may be volume % or mol %.

In the description of the present disclosure, the purity of oxygen is not particularly limited when it is measured by a measurement method commonly used in the technical field to which the present disclosure belongs.

The air or oxygen may be supplied at a rate of, for example, about 1 L/min to 20 L/min, or, for example, about 1 L/min to 15 L/min, about 2 L/min to 10 L/min, or about 3 L/min to 7 L/min. Within this range, there is an advantage in that the positive electrode active material is easily separated from the current collector, and the separated positive electrode active material is easily sorted as a powder form.

The heat treatment time may be, for example, about 10 min to 5 h, about 30 min to 5 h, about 30 min to 2 h, or about 30 min to 1 h. Within this range, there is an advantage in that the current collector is not melted, and only the binder, etc., are removed so that the positive electrode active material is easily separated from the current collector.

In the description of the present disclosure, the heat treatment time is the time required for treatment at the corresponding heat treatment temperature, and the time required until the corresponding heat treatment temperature is reached is not calculated.

The positive electrode active material recovered in the step (a) may be directly subjected to a milling or annealing process without pre-washing. In this case, since the pre-washing process is omitted, there is an advantage in that the economic efficiency and productivity are greatly improved.

In the description of the present disclosure, pre-washing may mean washing performed before the lithium precursor is added, and post-washing may mean washing performed after the lithium precursor is added and annealing is performed.

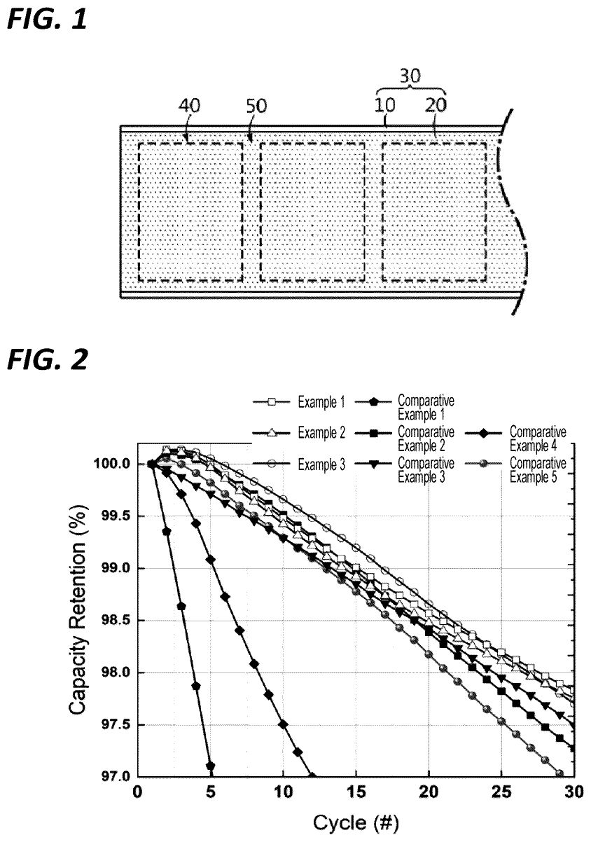

Referring to the following FIG. 1, an aluminum foil 10 which is a long sheet-type positive electrode current collector is coated with a positive electrode active material layer 20 containing a positive electrode active material, a conductive material, a binder, and the like, so as to produce a positive electrode sheet 30. Then, this sheet is punched to a certain size to produce positive electrode plates 40, and then a positive electrode scrap 50 is generated as the remaining portion. The punching is one means of cutting the positive electrode sheet.

Also, the positive electrode active material layer 20 is formed by coating the aluminum foil 10 with a slurry obtained by mixing a positive electrode active material, a conductive material, a binder, a solvent, and the like. Since the slurry is very sensitive to the environment such as temperature, it is difficult to determine coating conditions. Then, a waste positive electrode sheet such as the positive electrode scrap 50 is generated until conditions for manufacturing the positive electrode sheet 30 of the desired quality are found through a certain test.

For reference, in the following examples, the positive electrode scrap 50 was used as a waste positive electrode.

### (b) Step of Adding Lithium Precursor to Recovered Positive Electrode Active Material and Performing Annealing

The positive electrode active material recycling method of the present disclosure may include the step (b) of adding the lithium precursor to the recovered positive electrode active material and performing annealing at about 400° C. to 1,000° C. In this case, the crystal structure of the recycled positive electrode active material is restored, thereby providing a positive electrode active material excellent in efficiency, life characteristics and resistance characteristics. Then, there is an advantage in that the economic efficiency and productivity are greatly improved since the pre-washing process of the recovered positive electrode active material is omitted.

The annealing step may include a milling step before annealing, and may include, for example, a milling step before the lithium precursor is added. In this case, particles agglomerated during the heat treatment are released, and in the annealing step that is a subsequent process, the single-particle positive electrode active material is uniformly supplemented with the lithium precursor and then through the heat treatment, the crystal structure is restored. Thus, there are effects such as excellence in efficiency, life characteristics and resistance characteristics. Unlike a secondary-particle positive electrode active material, the single-particle positive electrode active material has fewer pores in particles. In addition, when the particles are agglomerated, it is difficult to uniformly replenish the positive electrode active material with the lithium precursor and to perform heat treatment. Thus, the agglomerated particles are released through the milling. Meanwhile, the state of the recovered secondary-particle positive electrode active material is different from that of the single-particle positive electrode active material. Thus, the recovered secondary-particle positive electrode active material has no milling effect according to the present disclosure, and is not transformed into the single-particle positive electrode active material even if milled.

Also, since the recovered positive electrode active material is directly milled without the pre-washing process, lithium loss caused by washing does not occur. There is an effect of further improving efficiency, life characteristics, and resistance characteristics.

The milling may be performed by using, for example, a centrifugal mill, a jet mill, or a pin mill. In one embodiment, when the milling process is performed by using the pin mill, there is an advantage in that the agglomerated particles are uniformly released and the surface of the positive electrode active material is not damaged.

The milling may be performed, for example, at about 6,000 rpm to 18,000 rpm, or, for example, at about 8,000 rpm to 16,000 rpm, at about 10,000 rpm to 13,000 rpm, or at about 11,000 rpm to 13,000 rpm. Within this range, the particle agglomeration of the single-particle positive electrode active material is released, and in the annealing step that is a subsequent process, heat treatment is uniformly performed. Thus, the crystal structure restoration of the recycled positive electrode active material is substantially improved, and then there are effects such as excellence in efficiency, life characteristics and resistance characteristics.

In the annealing step (b), the lithium precursor is added to the recovered positive electrode active material, and annealing may be performed in the air or oxygen (O₂) atmosphere. In one embodiment, annealing in air leads to an improvement of crystallinity of the positive electrode active material such as crystallinity increase or crystal structure restoration. Thus, there is an effect of improving the battery characteristics of the recycled positive electrode active material.

The annealing temperature may be, for example, about 500° C. to 900° C., about 600° C. to 880° C., or about 700° C. to 800° C. This case leads to an improvement of crystallinity of the positive electrode active material such as crystallinity increase or crystal structure restoration. Thus, there is an effect of improving the battery characteristics of the recycled positive electrode active material.

The lithium precursor may be at least one type selected from, for example, LiOH, Li₂CO₃, LiNO₃, and Li₂O.

In the step (b), the lithium precursor may be added at least in an amount reduced from the molar ratio of lithium in the positive electrode active material in the step (a), on the basis of the amount of lithium in the recovered positive electrode active material. For example, in a case where the positive electrode active material recovered in the step (a) is the positive electrode active material represented by the above formula 1, the lithium precursor may be added in such an amount that the molar ratio of lithium is about 0.0001 to 0.2 when the molar ratio of lithium in the positive electrode active material is 1, or in such an amount that the molar ratio of lithium is, for example, about 0.001 to 0.1, about 0.001 to 0.07, about 0.001 to 0.03, about 0.001 to 0.02, about 0.005 to 0.017, about 0.007 to 0.015, or about 0.009 to 0.013. Within these ranges, the shortage of lithium in the recycled positive electrode active material is filled up, leading to improvement of crystallinity such as crystallinity increase or crystal structure restoration. Thus, there is an advantage in that the battery characteristics of the recycled positive electrode active material are improved.

In another example, the lithium precursor may be added in an amount corresponding to about 1 mol % to 40 mol % when lithium included in the raw-material positive electrode active material is 100 mol %, or may be added in, for example, an amount corresponding to about 1 mol % to 30 mol % or about 7 mol % to 20 mol %. Within these ranges, a residual precursor that can increase the resistance in the recycled positive electrode active material does not remain, which is very useful for improving battery characteristics. Then, there is an economic advantage because the crystal structure may be restored with a smaller amount of lithium precursor than before.

The annealing temperature can be adjusted within a limited range depending on the melting point of the lithium precursor. For example, for LiCO₃ having a melting point of about 723° C., for example, annealing may be performed at about 700° C. to 900° C., or at about 710° C. to 780° C. For LiOH having a melting point of 462° C., for example, annealing may be performed at about 400° C. to 750° C., about 500° C. to 720° C., or about 600° C. to 720° C. Within these ranges, the crystal structure is restored, and thus, there are effects such as excellence in the efficiency, life characteristics, and resistance characteristics of batteries.

It is desirable that the annealing time may be, for example, about 1 h or more or 15 h or less, or, for example, about 1 h to 15 h, about 2 h to 10 h, about 3 h to 8 h, about 4 h to 6 h, or about 5 h. Within these ranges, the crystal structure is sufficiently restored, the crystallite size is larger than that of the secondary particles, and the ion conductivity is improved, leading to the effect of excellent capacity characteristics.

The annealing temperature may be reached at a heating rate of, for example, about 1° C./min to 10° C./min, about 1° C./min to 7° C./min, or about 2° C./min to 4° C./min. In this case, there is an effect of further increasing the crystallinity of the recycled positive electrode active material, thereby improving the battery characteristics of the recycled positive electrode active material.

The annealing step includes, for example, a cooling process, and the cooling process may be, for example, natural cooling in a furnace. In this case, there is an effect of further increasing the crystallinity of the recycled positive electrode active material, thereby improving the battery characteristics of the recycled positive electrode active material.

In the description of the present disclosure, annealing may follow the definition used in the technical field to which the present disclosure belongs, and may be defined as, for example, a heat treatment operation. The heat treatment operation heats a positive electrode active material with a deformed structure or lattice defects, at a temperature equal to or higher than a recrystallization temperature at which atoms of main components can be sufficiently diffused and moved, for an appropriate period of time, so that deformation or lattice defects is treated and the crystallinity is increased.

### (c) Step of Washing Annealed Positive Electrode Active Material (Post-Washing)

The positive electrode active material recycling method of the present disclosure includes the step (c) of washing the annealed positive electrode active material with the washing solution. In this case, the lithium precursor that is likely to remain on the surface of the positive electrode active material is removed with a washing solution. Then, there is an advantage in that a reaction between the residual lithium precursor and the electrolyte is prevented, thereby suppressing the degradation of battery performance and gas generation.

The washing step may include a milling step before the annealed positive electrode active material is washed. In this case, agglomerated particles are released and are uniformly dispersed so that the lithium precursor and/or fluorine are effectively removed with a small amount of washing solution, thereby reducing wastewater. Then, in the application to a battery, there is an advantage in that the charging capacity, the resistance characteristics and the capacity characteristics are improved.

The milling may be performed by using, for example, a centrifugal mill, a jet mill, or a pin mill. For example, when milling is performed by using a pin mill before washing, there is an advantage in that the agglomerated particles are uniformly released and the surface of the positive electrode active material is not damaged.

The milling may be carried out at, for example, about 6,000 rpm to 18,000 rpm, about 8,000 rpm to 16,000 rpm, about 10,000 rpm to 13,000 rpm, or about 11,000 rpm to 13,000 rpm. Within these ranges, agglomerated particles of the positive electrode active material are released to form a uniform dispersion shape, and impurities are easily removed in the post-washing process. Thus, there is an advantage in that the charging capacity, resistance characteristics and capacity characteristics are improved.

The washing may include a step of mixing the annealed positive electrode active material or the milled positive electrode active material with a washing solution, followed by a filtering step, and a step of drying the solid positive electrode active material obtained after the filtration. In this case, there is an effect of effectively removing excess lithium that tends to remain in the positive electrode active material. Also, in this case, lithium precursors such as LiOH and Li₂CO₃ and/or fluorine, which tend to remain on the surface of the positive electrode active material, are effectively removed with a small amount of washing solution, and thus there is an effect of reducing wastewater.

The annealed positive electrode active material or the milled positive electrode active material may be mixed with the washing solution may be mixed at a weight ratio of, for example, about 1:0.5 to 1:5.5, or at a weight ratio of, for example, about 1:0.5 to 1:4.5, about 1:0.5 to 1:3.5, or about 1:0.5 to 1:2.5. In this case, lithium precursors such as LiOH and Li₂CO₃ and/or fluorine, which tend to remain on the surface of the positive electrode active material, are effectively removed with a small amount of washing solution, and thus there is an effect of reducing wastewater.

The washing solution may be water or a basic lithium compound aqueous solution. In one embodiment, when water is used as the washing solution, lithium precursors such as LiOH and Li₂CO₃ are effectively removed with a small amount of washing solution. The lithium precursors are more likely to remain due to lithium excessively added to suppress a cation mixing phenomenon that is likely to occur in the recycled positive electrode active material, for example, the recycled mid-nickel positive electrode active material. There is an effect of greatly improving the output performance of a battery without requiring wastewater treatment.

The water is, for example, distilled water or deionized water. In this case, lithium precursors such as LiOH and Li₂CO₃, which are likely to remain on the surface of the recycled positive electrode active material, are effectively removed with a small amount of washing solution. Then, there is the effect of reducing wastewater and greatly improving the output performance of a battery.

The basic lithium compound aqueous solution may contain, for example, a lithium compound in an amount greater than about 0 wt % and 15 wt % or less, or in an amount greater than about 0 wt % and 10 wt % or less. In this case, lithium precursors such as LiOH and Li₂CO₃ and/or fluorine, which are likely to remain on the surface of the positive electrode active material, are effectively removed with a small amount of washing solution. Then, there is the effect of reducing wastewater and greatly improving the output performance of a battery.

The annealed positive electrode active material and the washing solution are mixed, for example, by stirring. The stirring is not particularly limited, but mechanical stirring or ultrasonic stirring may be used.

The stirring may be performed, for example, within about 30 min, about 20 min, or about 15 min, or for 5 min to 10 min. Within these ranges, residual lithium is effectively removed.

### (d) Step of Performing Surface-Coating of Washed Positive Electrode Active Material to Obtain Reusable Positive Electrode Active Material

The positive electrode active material recycling method of the present disclosure includes the step (d) of performing surface-coating of the washed positive electrode active material to obtain a reusable positive electrode active material. In this case, there is an effect of improving the structural stability and the electrochemical performance while maintaining the excellent properties of the positive electrode active material itself, as they are.

In the surface-coating, the surface is coated with a coating agent containing, for example, at least one type of a metal, an organic metal, and a carbon component in a solid or liquid manner, and then heat treatment is performed at about 100° C. to 1,200° C. In this case, there is an effect of improving the structural stability and the electrochemical performance while maintaining the excellent properties of the positive electrode active material itself, as they are.

The metal-containing coating agent is a coating agent that contains for example at least one type selected from B, W, Al, Ti, Mg, Ni, Co, Mn, Si, Zr, Ge, Sn, Cr, Fe, V, and Y, or may be a coating agent containing at least one type selected from B, W, Al, Ti, and Mg, a coating agent containing boron (B), tungsten (W) or a mixture thereof, a coating agent containing tungsten (W) and boron (B), or a coating agent containing tungsten boride (WB). In these cases, there is an effect of improving resistance characteristics and life characteristics.

The boron-containing coating agent may be, for example, at least one type selected from H₃BO₃, B₂O₃, C₆H₅B(OH)₂, (C₆H₅O)₃B, [CH₃(CH₂)₃O]₃B, C₁₃H₁₉BO₃, C₃H₉B₃O₆, and (C₃H₇O)₃B. In one embodiment, when H₃BO₃ is used as the boron-containing coating agent, there is an effect of improving resistance characteristics and life characteristics.

The metal-containing coating agent may be, for example, an oxide or an acid that includes the metal as an element in the molecule.

The organic metal-containing coating agent is not particularly limited as long as it is an organic metal compound-containing coating agent that contains the above metal and is commonly used in the technical field to which the present disclosure belongs. It may be, for example, metal alkoxide.

The carbon component-containing coating agent is not particularly limited as long as it is a coating agent that contains a carbon component and is commonly used in the technical field to which the present disclosure belongs. As a specific example, it may be sugar such as sucrose.

The coating agent may be included in, for example, an amount of about 0.001 mol % to 0.3 mol % relative to 1 mol % of metal in the uncoated positive electrode active material on the basis of components actually coated on the positive electrode active material surface excluding a solvent, or may be included in an amount of about 0.01 mol % to 0.3 mol %, about 0.01 mol % to 0.15 mol %, about 0.01 to 0.1 mol %, or about 0.01 mol % to 0.05 mol %. Within these ranges, there is an effect of improving the structural stability and the electrochemical performance while maintaining the excellent properties of the positive electrode active material itself, as they are.

The heat treatment temperature may be, for example, about 100° C. to 1,000° C., about 200° C. to 1,000° C., or about 200° C. to 500° C. Within these ranges, performance degradation caused by the thermal decomposition of the recycled positive electrode active material does not occur. There is an effect of improving the structural stability and the electrochemical performance.

The time required for carrying out the heat treatment may be, for example, about 1 h to 16 h or about 3 h to 7 h. Within these ranges, there is an effect of improving the structural stability and the electrochemical performance while maintaining the properties of the positive electrode active material itself, as they are.

The coating method is not particularly limited as long as it is a coating method commonly used in the technical field to which the present disclosure belongs. Examples thereof may include a liquid method in which a liquid coating agent is prepared and is mixed with a positive electrode active material, a mechanochemical method using the high mechanical energy of ball milling, a fluid bed coating method, a spray drying method, a precipitation method that allows a coating agent to be precipitated on the positive electrode active material surface in an aqueous solution state, a method utilizing a reaction between a gaseous coating agent and a positive electrode active material, and a sputtering method.

The metal, organic metal and carbon component may be, for example, spherical, plate-shaped, prismatic or needle-shaped, and these shapes may be controlled by changing process conditions, etc. during a manufacturing process. The definition of each shape is not particularly limited as long as it follows the definition commonly recognized in the technical field to which the present disclosure belongs.

For the coating agent, for example, the average diameter may be about 1 nm to 1000 nm, and the specific surface area may be about 10 m²/g to 100 m²/g, and the average diameter may be about 10 nm to 100 nm, and the specific surface area may be about 20 m²/g to 100 m²/g. Within these ranges, the coating agent uniformly adheres to the surface of the recycled positive electrode active material, and provides the structural stability of the recycled positive electrode active material. This prevents lattice deformation or crystal structure collapse of the positive electrode active material, thereby improving the problems of degradation of life characteristics and electrochemical performance.

In the description of the present disclosure, the average diameter may be measured by a measurement method commonly used in the technical field to which the present disclosure belongs, and may be measured by using, for example, a laser diffraction method. Specifically, in order to calculate the average particle diameter (D₅₀) based on 50% of the particle diameter distribution in a measuring device, positive electrode active material particles are dispersed in a dispersion medium, and then are introduced into a commercially available laser diffraction particle size measurement device such as Microtrac MT 3000, and are irradiated with ultrasonic waves of about 28 kHz with an output of 60 W.

In the description of the present disclosure, the specific surface area may be measured by a measurement method commonly used in the technical field to which the present disclosure belongs, and may be measured by, for example, a Brunauer-Emmett-Teller (BET) method. Specifically, it may be calculated from a nitrogen gas adsorption amount by using BELSORP-mini II of BEL Japan under a liquid nitrogen temperature (77K).

The positive electrode active material recycled by the positive electrode active material recycling method may contain, for example, about 5,700 mg/kg to 6,500 mg/kg, about 5,800 mg/kg to 6,300 mg/kg, or about 5,800 mg/kg to 6,100 mg/kg of fluorine (F). Within these ranges, there are effects such as excellence in charging capacity, resistance characteristics and capacity characteristics.

In the description of the present disclosure, the fluorine (F) content may be measured through an IC analysis device. Here, a general IC analysis device commonly used in laboratories may be used for measurement, but there is no deviation depending on the measuring device or method.

In the positive electrode active material recycled according to the positive electrode active material recycling method, the a-axis lattice parameter measured by an XRD analysis may be, for example, about 2.8753 Å to 2.8772 Å, about 2.8760 Å to 2.8770 Å, about 2.8762 Å to 2.8768 Å, or about 2.8764 Å to 2.8768 Å. Within these ranges, the positive electrode active material has a smaller a-axis lattice parameter than a raw-material positive electrode active material, and thus has a different lattice structure. There are effects such as excellence in the charging capacity, resistance characteristics and capacity characteristics.

In the positive electrode active material recycled by the positive electrode active material recycling method, the c-axis lattice parameter measured by an XRD analysis may be, for example, about 14.243 Å to 14.255 Å, about 14.245 Å to 14.254 Å, about 14.247 Å to 14.254 Å, or about 14.249 Å to 14.254 Å. Within these ranges, the lithium concentration in the lattice is increased in the c-axis indicating a z-axis direction in a layered structure. There are effects such as excellence in charging capacity, resistance characteristics, and capacity characteristics.

In the positive electrode active material recycled according to the positive electrode active material recycling method, the cell volume measured by, for example, an XRD analysis may be, for example, about 101.968 Å to 102.168 Å³, about 101.980 Å to 102.163 Å³, about 102.000 Å to 102.158 Å³, or about 102.100 Å to 102.153 Å³. Within these ranges, there are effects such as excellence in charging capacity, resistance characteristics, and capacity characteristics.

In the positive electrode active material recycled according to the positive electrode active material recycling method, the crystallite size measured by, for example, an XRD analysis, may be, for example, greater than about 130 nm and 136 nm or less, about 131 nm to 135 nm, or about 131 nm to 134 nm. Within these ranges, the crystallite size is larger than that of the secondary particles, and the ion conductivity is improved, leading to the effect of excellent capacity characteristics.

Also, the present disclosure may provide a recycled positive electrode active material that is characteristically manufactured by the positive electrode active material recycling method. When the recycled positive electrode active material of the present disclosure is applied, there are effects such as excellence in initial discharging capacity, output performance, capacity characteristics, and resistance characteristics of batteries.

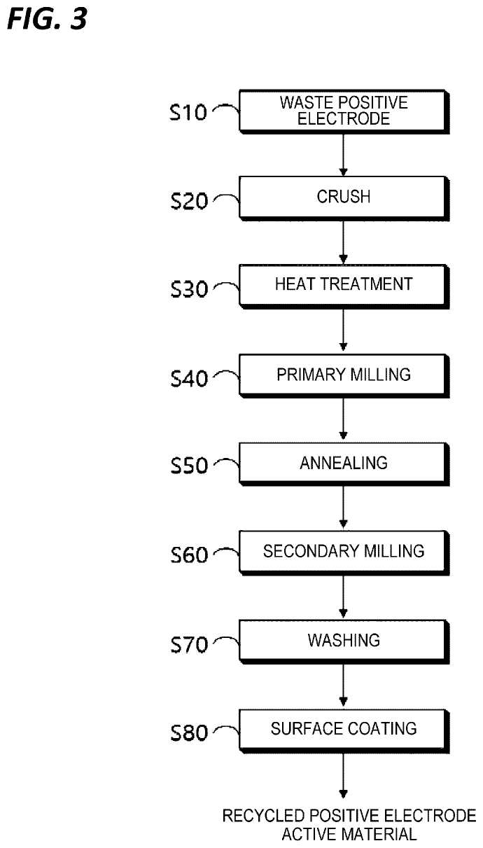

The following FIG. 3 is a flowchart of the recycling process of a positive electrode active material according to one embodiment of the present disclosure.

Referring to FIG. 3, first, a positive electrode scrap is prepared as a waste positive electrode (step S10).

For example, an aluminum foil is coated with a slurry that is prepared by adding NMP (N-methyl pyrrolidone) to single-particle mid-nickel NCM-based lithium composite transition metal oxide, carbon black and polyvinylidene fluoride, and mixing these, and is dried in a vacuum oven at about 120° C. to produce a positive electrode sheet. After this is punched to obtain positive electrode plates with a predetermined size, a remaining positive electrode scrap can be prepared.

The positive electrode scrap has a positive electrode active material layer on the aluminum foil. After the solvent evaporates, the positive electrode active material layer has a structure where the binder binds the positive electrode active material and the conductive material. Therefore, when the binder is removed, the positive electrode active material is separated from the aluminum foil.

Next, the prepared positive electrode scrap is crushed into an appropriate size (step S20).

Here, crushing includes cutting or shredding the positive electrode scrap into a size that is easy to handle. For example, the crushed positive electrode scrap may have a size of 1 cm×1 cm. For the crushing, for example, various dry grinding equipment such as a hand-mill, a pin-mill, a disc-mill, a cutting-mill, and a hammer-mill may be used, or a high-speed cutter may be used to increase productivity.

Whether to carry out the crushing or the size of the piece may be preferably determined by considering the handling of the positive electrode scrap and the characteristics required by equipment used in the subsequent process. For example, when equipment capable of performing continuous processing is used, the positive electrode scrap must be crushed into smaller pieces because flowability should be good.

Next, the positive electrode scrap is subjected to the heat treatment to recover the positive electrode active material (step S30). Here, the heat treatment is carried out to thermally decompose the binder in the active material layer. As described above, through the heat treatment, the binder and the conductive material in the active material layer are thermally decomposed into CO₂ and H₂O and are removed. Since the binder is removed, the positive electrode active material is separated from the current collector, and the separated positive electrode active material is easily sorted as a powder form. Therefore, just through the step S30, the active material layer may be separated from the current collector, and then, the positive electrode active material in the active material layer may be recovered as a powder form.

The recovered positive electrode active material may contain single particles, and does not include, for example, secondary particles. In this case, there is an effect of providing a positive electrode active material, in which there is no particle breakage during the electrode manufacturing process so that a battery performance degradation caused by fine powder does not occur, life characteristics are excellent in the high-voltage environment, the thermal stability is high, and the amount of gas generated by charging/discharging is small.

The heat treatment may be performed in air or in an oxygen atmosphere, for example, in air. When the heat treatment is performed in a reducing gas or inert gas atmosphere, the binder and the conductive material are carbonized without being thermally decomposed. Due to carbonization, a carbon component remains on the surface of the positive electrode active material, and then the performance of the reusable positive electrode active material is reduced. However, when the heat treatment is performed in air or in an oxygen atmosphere, the carbon components in the binder and the conductive material react with oxygen and disappear as gases such as CO and CO₂. Thus, both the binder and the conductive material are removed.

The heat treatment may be performed at, for example, about 300° C. to 650° C., or may be performed at about 550° C. in one embodiment.

The heat treatment may be performed at a temperature increase rate of, for example, about 1° C./min to 20° C./min, or about 3° C./min to 10° C./min, or may be performed under the condition of about 5° C./min in one embodiment. Within these ranges, there is an advantage in that the heat treatment can be implemented without causing a strain on the heat treatment equipment, and thermal shock, etc. are not caused in positive electrode scraps.

The heat treatment may be performed for a period of time in which, for example, the binder can be sufficiently thermally decomposed, for example, for about 30 min or more, or about 30 min to 5 h. In one embodiment, the heat treatment may be performed for about 30 min. Within this range, the binder is sufficiently thermally decomposed and then there is an effect of excellent efficiency of thermal decomposition.

The heat treatment may be performed by using, for example, various types of furnaces, e.g., a box-type furnace. In one embodiment, the heat treatment may be performed by a rotary kiln capable of performing continuous processing in consideration of productivity.

After the heat treatment, slow cooling or rapid cooling may be performed in the atmosphere.

Next, the recovered positive electrode active material is primarily milled (step S40).

In the primary milling step, it is important to directly mill the recovered positive electrode active material without a pre-washing process. In this case, the agglomerated positive electrode active material is released without damaging the surface of the single-particle positive electrode active material, thereby making particles uniform. Since no washing process is carried out, the lithium loss caused by washing does not occur. There is an effect of further improving efficiency, life characteristics, and resistance characteristics.

The primary milling may be performed by using, for example, a centrifugal mill, a jet mill, or a pin mill. For example, when the primary milling is performed by using the pin mill, there is an advantage in that the particles are made uniform without damaging the surface of the recovered single-particle positive electrode active material, thereby improving battery characteristics.

The primary milling may be performed at, for example, about 6,000 rpm to 18,000 rpm, or about 12,000 ppm. Within this range, there is an advantage in that the particles are made uniform without damaging the surface of the single-particle positive electrode active material, thereby improving battery characteristics.

Next, a lithium precursor is added to the primarily milled positive electrode active material and then annealed (step S50).

Since lithium loss occurs in the positive electrode active material through the previous step S30, the annealing step S50 compensates for such an amount of lithium loss. In addition, since a deformed structure (e.g., Co₃O₄ in the case of an LCO active material) may appear on the single-particle positive electrode active material surface through the previous step, in the step S50, through annealing, the crystal structure of the single-particle positive electrode active material is restored so as to improve battery characteristics of the recycled single-particle positive electrode active material or to restore these to the level of a new positive electrode active material. Here, ‘new’ is a concept opposite to ‘recycled’, means something that is first made, and is the same term as ‘raw-material’ used in the detailed description and examples of the present disclosure.

The lithium precursor may be, for example, at least one of LiOH, Li₂CO₃, LiNO₃ and Li₂O, and, for example, LiOH may be used.

In one embodiment, the lithium precursor may be added at least in a lost amount of the molar ratio of lithium in comparison to the molar ratio of lithium to other metals in the new positive electrode active material used for the positive electrode active material layer. When an excessive amount of lithium precursor is added compared to the lost amount of lithium, an unreacted lithium precursor will remain in the recycled positive electrode active material. This serves to increase resistance, and thus an appropriate amount of lithium precursor needs to be added. For example, when the molar ratio of lithium to other metals in the new positive electrode active material is 1, a lithium precursor may be added in such an amount that the molar ratio of lithium is about 0.001 to 0.4, or in such an amount that the molar ratio of lithium is about 0.01 to 0.2.

For example, when a lithium precursor is added at a molar ratio of 0.09 to 0.1 (based on a lithium metal), which is the loss ratio based on the lithium content in the new positive electrode active material, on the basis of the ICP analysis result, a capacity improvement effect equivalent to that of the new positive electrode active material is found. Here, the ICP analysis result has an error value of about ±0.02.

The annealing is performed in oxygen (O₂) or air, for example, under the condition of about 400° C. to 1,000° C., or is performed in air under the condition of about 700° C.

In one embodiment, the annealing temperature may exceed the melting point of the lithium precursor. When Li₂CO₃ is used as the lithium precursor, the annealing temperature may be about 700° C. to 900° C., about 710° C. to 780° C., or about 750° C. to 780° C. Also, when LiOH is used as the lithium precursor, the annealing temperature may be about 400° C. to 750° C., about 500° C. to 720° C., or about 600° C. to 720° C.

The annealing time may be about 1 h to 15 h in consideration of crystal structure restoration, and may be, for example, about 4 h to 6 h. As for the annealing equipment, the same or similar equipment as that in the heat treatment step S30 may be used.

Next, the annealed positive electrode active material is secondarily milled (step S60).

In the secondary milling step S60, particles agglomerated through the annealing step S50 are released so that the particle size of the recycled positive electrode active material may be reduced and become similar to the particle size of the positive electrode active material in the waste positive electrode. This improves battery characteristics. Then, there is an advantage in that in a subsequent washing process, the lithium precursor and/or fluorine are effectively removed with a small amount of washing solution, thereby reducing wastewater.

The secondary milling may be carried out by using, for example, a centrifugal mill, a jet mill, or a pin mill. In one embodiment, when the milling process is carried out by using a pin mill, there is an advantage in that the particle size is reduced without damaging the particles of the recycled positive electrode active material.

The secondary milling may be carried out at, for example, about 6000 rpm to 16,000 rpm, or at 12,000 rpm. Within this range, there are advantages of excellent milling efficiency, reduction in the particle size of the recycled positive electrode active material, and excellent productivity.

Next, the secondarily milled positive electrode active material is washed (step S70).

The washing step S70 removes the lithium precursor that did not participate in the reaction in the annealing step S50 and is present in the form of LiOH and Li₂CO₃ on the surface of the positive electrode active material. Lithium impurities such as lithium carbonate (Li₂CO₃) remaining on the surface of the recycled positive electrode active material must be removed because they may later react with the electrolyte, thereby reducing the battery performance and generating gas.

In the washing step S70, the positive electrode active material obtained from the annealing step S50 and a washing solution are mixed at a weight ratio of about 1:0.5 to 1:5.5, e.g., a weight ratio of about 1:1, and then are filtered. Then, the obtained solid positive electrode active material is dried. In this case, the particles agglomerated through milling in the previous step are released. Thus, there is an advantage in that the residual lithium is cleanly removed with a small amount of washing solution, reducing wastewater.

As for the washing solution, distilled water or a basic lithium compound aqueous solution containing a basic lithium compound in an amount of greater than 0 wt % and 10 wt % or less may be used. In one embodiment, the distilled water used as the washing solution is safe and inexpensive, and also there is an advantage in that transition metals present in the recycled positive electrode active material are not eluted.

The annealed positive electrode active material and the washing solution are mixed, for example, by stirring. The stirring is not particularly limited, but, for example, mechanical stirring or ultrasonic stirring may be used.

The mechanical stirring is carried out under the conditions of, for example, about 250 rpm to 350 rpm and about 3 min to 10 min.

The filtration may be, for example, vacuum filtration using a filter, and the drying may be vacuum drying at about 120° C. to 140° C.

Next, surface-coating is performed on the washed positive electrode active material (step S80).

In the surface-coating, the surface is coated with a coating agent containing, for example, a metal, an organic metal, or a carbon component in a solid or liquid manner, and then heat treatment is performed. When the heat treatment temperature is too low, the surface protective layer of desired dissimilar metal is not formed, whereas when the heat treatment temperature is too high, the battery performance is reduced due to the thermal decomposition of the positive electrode active material.

In one embodiment, when the washed positive electrode active material is coated with a metal oxide or an acid of B, W, or B-W, and is subjected to heat treatment, a surface protective layer such as a lithium boroxide layer is formed on the positive electrode active material surface.

The solid or liquid method of the surface-coating may be a method such as, for example, mixing, milling, spray drying or grinding.

When the molar ratio of lithium:other metals in the positive electrode active material is about 1:1 in the annealing step S50, due to a reaction between lithium in the recycled positive electrode active material with the coating agent in the surface-coating step S60, the molar ratio of lithium:other metals in the positive electrode active material is less than about 1:1. Then, such a recycled positive electrode active material cannot sufficiently exhibit 100% of the battery capacity. However, when an excessive amount of lithium precursor is added in the annealing step S40 such that the content of lithium is larger than that of other metals in the recycled positive electrode active material, by a molar ratio of about 0.0001 to 0.1, the molar ratio of lithium:other metals in the positive electrode active material naturally becomes 1:1 due to the formation of the surface protective layer in the surface-coating step S60. Then, the battery capacity reduction does not occur.

### Secondary Battery

The secondary battery of the present disclosure includes the recycled single-particle positive electrode active material. In this case, since lithium remaining on the positive electrode active material surface is significantly reduced, the initial discharging capacity, output performance, capacity characteristics, and resistance characteristics are excellent. Also, this secondary battery is environmentally friendly because an acid and an organic solvent are not used in the recovery and recycling process of the positive electrode active material. In particular, since a pre-washing process is omitted, there are effects such as excellence in economic efficiency and productivity.

The secondary battery of the present disclosure may include the contents of both the above-described recycled single-particle positive electrode active material and the recycling method thereof. Therefore, here, redundant descriptions thereof will be omitted.

Hereinafter, preferred examples are presented to help the understanding of the present disclosure, but the following examples are only illustrative of the present disclosure, and it is obvious to those skilled in the art that various changes and modifications are possible within the scope of the present disclosure and the technical idea range. Then, it is also natural that such changes and modifications fall within the appended claims.

### EXAMPLE

### Example 1

A positive electrode scrap (a current collector: an aluminum foil, a positive electrode active material: NCM-based lithium composite transition metal oxide (containing 61 mol % of Ni based on 100 mol % of all remaining metals except for Li)), which was discarded after positive electrode plates were obtained by punching, was crushed, and was subjected to heat treatment in air at 550° C. for 30 min so as to remove a binder and a conductive material. After the current collector and the positive electrode active material were separated from each other, the positive electrode active material was recovered. Here, the heat treatment temperature was reached at a temperature increase rate of 5° C./min, and air was supplied at 3 L/min.

The recovered positive electrode active material was confirmed to be single particles through SEM photos.

The recovered positive electrode active material was directly primarily milled at 12,000 rpm by using a pin mill without pre-washing.

When lithium in the raw-material positive electrode active material is 100 mol %, LiOH as a lithium precursor was added to the primarily milled positive electrode active material in such an amount that lithium corresponding to 10 mol % can be provided. Then, annealing was performed in air at a calcination temperature of 700° C. for 5 h. Here, air was supplied at 3 L/min.

The annealed positive electrode active material was secondarily milled at 12,000 rpm by using a pin mill.

The secondarily milled positive electrode active material and distilled water were mixed at a weight ratio of 1:1 and were stirred for 5 min under the condition of 300 rpm. Then, through vacuum filtration, a solid was obtained. The solid was vacuum-dried at 130° C. for 12 h to obtain the washed positive electrode active material.

The washed positive electrode active material was coated with boric acid and then was heated for 5 h at 300° C. to produce a final recycled positive electrode active material. Here, the boric acid was added at 500 ppm on the basis of the total weight of the positive electrode active material, the heat treatment temperature was reached at a temperature increase rate of 2° C./min, and the air was supplied at 3 L/min.

Here, the molar ratio of lithium to other metals in the positive electrode active material was measured by using an ICP analysis device, etc. Here, a general ICP analysis device commonly used in laboratories may be used for measurement, but there is no deviation depending on the measuring device or method.

In the description of the present disclosure, unless otherwise defined, ppm is based on weight.

### Example 2

A recycled positive electrode active material was manufactured in the same manner as in Example 1 except that primary milling in Example 1 was not performed.

### Example 3

A recycled positive electrode active material was manufactured in the same manner as in Example 1 except that secondary milling in Example 1 was not performed.

### Comparative Example 1

A recycled positive electrode active material was manufactured in the same manner as in Example 1 except that NCM-based lithium composite transition metal oxide in a positive electrode scrap discarded after positive electrode plates were obtained by punching in Example 1 (containing 61 mol % of Ni based on 100 mol % of all remaining metals except for Li, single particles) was changed to NCM-based lithium composite transition metal oxide (containing 61 mol % of Ni based on 100 mol % of all remaining metals except for Li, secondary particles).

The positive electrode active material recovered after heat treatment was confirmed to be secondary particles through SEM photos.

### Comparative Example 2

A positive electrode scrap (a current collector: an aluminum foil, a positive electrode active material: NCM-based lithium composite transition metal oxide (containing 61 mol % of Ni based on 100 mol % of all remaining metals except for Li)), which was discarded after positive electrode plates were obtained by punching, was crushed, and was subjected to heat treatment in air at 550° C. for 30 min so as to remove a binder and a conductive material. After the current collector and the positive electrode active material were separated from each other, the positive electrode active material was recovered. Here, the heat treatment temperature was reached at a temperature increase rate of 5° C./min, and air was supplied at 3 L/min.

The recovered positive electrode active material was confirmed to be single particles through SEM photos.

The recovered positive electrode active material was washed by being immersed and stirred at the same time in distilled water. Here, after the recovered positive electrode active material and the distilled water were stirred at a weight ratio of 1:10 at 500 rpm for 10 min, vacuum filtration was performed by using a filter so that only an active material was extracted.

The washed positive electrode active material was dried at 100° C. overnight. Then, when lithium in the raw-material positive electrode active material is 100 mol %, LiOH as a lithium precursor was added in such an amount that lithium corresponding to 10 mol % can be provided. Then, annealing was performed in air at a calcination temperature of 700° C. for 5 h. Here, air was supplied at 3 L/min.

The annealed positive electrode active material and distilled water were mixed at a weight ratio of 1:1 and were stirred for 5 min under the condition of 300 rpm. Then, through vacuum filtration, a solid was obtained. The solid was vacuum-dried at 130° C. for 12 h to obtain the washed positive electrode active material.

The washed positive electrode active material was coated with boric acid and then was heated for 5 h at 300° C. to produce a final recycled positive electrode active material. Here, the boric acid was added at 500 ppm on the basis of the total weight of the positive electrode active material, the heat treatment temperature was reached at a temperature increase rate of 2° C./min, and the air was supplied at 3 L/min.

### Comparative Example 3

A recycled positive electrode active material was manufactured in the same manner as in Example 1 except that in the surface-coating step of Example 1, heating was performed at 300° C. for 5 h with no addition of boric acid to produce a final recycled positive electrode active material.

### Comparative Example 4

A positive electrode scrap (a current collector: an aluminum foil, a positive electrode active material: NCM-based lithium composite transition metal oxide (containing 61 mol % of Ni based on 100 mol % of all remaining metals except for Li)), which was discarded after positive electrode plates were obtained by punching, was crushed, and was subjected to heat treatment in air at 550° C. for 30 min so as to remove a binder and a conductive material. After the current collector and the positive electrode active material were separated from each other, the positive electrode active material was recovered. Here, the heat treatment temperature was reached at a temperature increase rate of 5° C./min, and air was supplied at 3 L/min.

The recovered positive electrode active material was confirmed to be single particles through SEM photos.

The recovered positive electrode active material was directly subjected to only primary milling by using a pin mill at 12,000 rpm without being washed so as to produce a recycled positive electrode active material. Annealing, secondary milling, post-washing and coating were not performed.

### Comparative Example 5

Instead of a reusable active material, new (fresh) NCM-based lithium composite transition metal oxide (containing 61 mol % of Ni based on 100 mol % of all remaining metals except for Li, average particle diameter: 3.99 μm) was prepared. The new positive electrode active material was confirmed to be single particles through SEM photos.

### Experimental Example I: Content of Fluorine (F)

The fluorine contents in the recycled or new positive electrode active materials manufactured or prepared in Examples 1 to 3 and Comparative Examples 1 to 5 were measured by using an ICP analysis device, and the results are noted in the following Table 1. Here, a general ICP analysis device commonly used in laboratories may be used for measurement, but there is no deviation depending on the measuring device or method.

TABLE 1

| Examples | F(mg/kg) |
|---|---|
| Example 1 | 5815 |
| Example 2 | 6300 |
| Example 3 | 6000 |
| Comparative Example 1 | 6050 |
| Comparative Example 2 | 160 |
| Comparative Example 3 | 5540 |
| Comparative Example 4 | 7200 |
| Comparative Example 5 | <10 |

As noted in the above Table 1, it can be found that the fluorine contents of the recycled positive electrode active materials of Examples 1 to 3 according to the present disclosure fall within a range of 5700 ppm to 6500 ppm.

In contrast, in the recycled positive electrode active material of Comparative Example 2, the fluorine content was reduced because washing was performed twice, but a large amount of wastewater was generated, and also there was a lot of lithium loss. In the recycled positive electrode active material of Comparative Example 3, the fluorine content was similar to that of Example 1. From this, it can be found that the surface-coating does not affect the fluorine content.

Also, the recycled positive electrode active material of Comparative Example 4, which was manufactured by performing only primary milling, had a significant increase in fluorine content compared to Example 1.

Also, the new positive electrode active material of Comparative Example 5 had a low fluorine content. In the recycled positive electrode active material containing secondary particles of Comparative Example 1, the fluorine content was similar to that of Examples.

### Experimental Example II: CHC Cell Evaluation

For the recycled or new positive electrode active materials manufactured or prepared in Examples 1 to 3 and Comparative Examples 1 to 5, the electrochemical performance was measured through the following CHC cell evaluation, and the results are noted in Table 2 below.
CHC cell evaluation: 97.5 wt % of the recycled positive electrode active material, 1.15 wt % of carbon black as a conductive material and 1.35 wt % of PVdF as a binder were weighed, and these were mixed with NMP to obtain a slurry. An aluminum foil was coated with this slurry to prepare a positive electrode, and then a cell (Coin Half Cell, CHC) was manufactured. Then, the electrochemical performance (charging capacity CH, discharging capacity DCH and charging/discharging efficiency Eff (%)) was evaluated with 3 to 4.45 V cut, and initial formation charging/discharging of 0.1 C/0.1 C, under the conditions that an electrolyte with a weight ratio of ethylene carbonate (EC):dimethyl carbonate (DMC):ethyl methyl carbonate (EMC) of 3:4:3 and other additives were included.

The charging/discharging efficiency was calculated by the following mathematical formula 1 and is noted in Table 2.

$$Charging / discharge effciency ( \% ) = [ Discharging capacity ( mAh / g ) Charging capacity ( mAh / g ) ] * 100 \qquad [ Mathematical formula 1 ]$$

TABLE 2

| | Charging | Discharging | |
|---|---|---|---|
| | Capacity | Capacity | Charging/Discharging |
| CHC capacity | (mAh/g) | (mAh/g) | Efficiency (%) |
| Example 1 | 217.0 | 197.0 | 90.8 |
| Example 2 | 216.3 | 196.2 | 90.7 |
| Example 3 | 216.7 | 196.4 | 90.6 |
| Comparative | 222.4 | 201.3 | 89.7 |
| Example 1 | | | |
| Comparative | 216.9 | 195.3 | 90 |
| Example 2 | | | |
| Comparative | 213.6 | 189.3 | 88.6 |
| Example 3 | | | |
| Comparative | 209.7 | 177.8 | 84.8 |
| Example 4 | | | |
| Comparative | 219.1 | 197.4 | 90.1 |
| Example 5 | | | |

As noted in the above Table 2, it can be found that the recycled positive electrode active material in Examples 1 to 3 according to the present disclosure is more excellent in charging capacity (CH), discharging capacity (DCH) and/or charging/discharging efficiency (Eff) than the recycled positive electrode active material or new positive electrode active material in Comparative Examples 1 to 5. In particular, it can be found that in Comparative Example 2 in which washing was performed instead of milling, the discharging efficiency and the charging/discharging efficiency were low compared to in Examples 1 to 3.

### Experimental Example III: XRD Analysis

Each of the recycled or new positive electrode active materials manufactured or prepared in Examples 1 to 3 and Comparative Examples 1 to 5 was subjected to an XRD analysis, and the a-axis lattice parameter, the c-axis lattice parameter, the cell volume, and the crystallite size were measured and are noted in the following Table 3.
Lattice parameter and crystallite size were measured through an XRD analysis, specifically an XRD analysis using Cu Kα X-rays. The lattice parameter was calculated by indexing data measured through XRD through Rietveld refinement, the cell volume was calculated by the product of the a-axis lattice parameter and the c-axis lattice parameter, and the crystallite size was calculated using the Scherrer equation for the XRD measurement data.

TABLE 3

| | a-axis lattice | c-axis lattice | Cell volume | Crystallite |
|---|---|---|---|---|
| XRD | parameter (Å) | parameter (Å) | (Å³) | size (nm) |
| Example 1 | 2.8768 | 14.253 | 102.148 | 134 |
| Example 2 | 2.8764 | 14.254 | 102.134 | 131 |
| Example 3 | 2.8765 | 14.251 | 102.116 | 133 |
| Comparative | 2.8741 | 14.234 | 101.820 | 140 |
| Example 1 | | | | |
| Comparative | 2.8766 | 14.252 | 102.132 | 129 |
| Example 2 | | | | |
| Comparative | 2.8776 | 14.250 | 102.189 | 162 |
| Example 3 | | | | |
| Comparative | 2.8796 | 14.256 | 102.369 | 122 |
| Example 4 | | | | |
| Comparative | 2.8776 | 14.250 | 102.187 | 165 |
| Example 5 | | | | |

As noted in the above Table 3, it can be found that in the recycled positive electrode active material (Examples 1 to 3) according to the present disclosure, the a-axis lattice parameter, the c-axis lattice parameter, the cell volume, and the crystallite size are different from those in the new positive electrode active material (Comparative Example 5). Specifically, the a-axis lattice parameter and the cell volume are smaller and the c-axis lattice parameter and the crystallite size are larger. From this, it can be found that due to milling before and/or after annealing, the crystal structure, and the crystallite size in the recycled single-particle positive electrode active material according to the present disclosure are different from those in the new positive electrode active material.

Also, it can be found that the a-axis lattice parameter, the c-axis lattice parameter, the cell volume, and the crystallite size in the recycled positive electrode active materials of Examples 1 to 3 are different from those in the recycled positive electrode active materials of Comparative Examples 1 to 4.

### Experimental Example IV: Evaluation of High-Temperature Life Characteristics

For CHC cells manufactured as described above, from the recycled or new positive electrode active materials manufactured or prepared in Examples 1 to 3, and Comparative Examples 1 to 5, the capacity retention rate was measured as follows, and the results are noted in the following FIG. 2.
Evaluation of high-temperature life characteristics: at 45° C., under the following conditions, for each cell, 30 cycles of charging/discharging were carried out. For each cycle, the capacity retention rate was calculated by the following mathematical formula 2 and is illustrated in the following FIG. 2.

Charging: 0.33 C, CC/CV, 4.5 V, 0.05 C cut-off

Discharging: 0.33 C, CC, 3.0 V, 0.05 C cut-off

$$Capacity retention rate ( \% ) = ( discharging capacity after N cyles / discharging capacity after 1 cycle ) * 100 \qquad [ Mathematical formula 2 ]$$

The following FIG. 2 is a graph illustrating the capacity retention rate according to the number of cycles (Cycle No.). This illustrates the evaluation results of life characteristics of the recycled single-particle positive electrode active materials (Examples 1 to 3) according to the present disclosure, in comparison to each of the recycled secondary-particle positive electrode active material (Comparative Example 1), the recycled positive electrode active material (Comparative Example 2) obtained by carrying out washing without milling, the recycled positive electrode active material (Comparative Example 3) obtained by carrying out heat treatment without addition of boric acid in the surface-coating step, the recycled positive electrode active material (Comparative Example 4) obtained by carrying out only the primary milling step, and the new positive electrode active material (Comparative Example 5).

Referring to this, it can be found that the recycled positive electrode active materials (Examples 1 to 3) according to the present disclosure are excellent in the capacity retention rate as compared to the recycled positive electrode active materials of Comparative Examples 1 to 4 and also the new positive electrode active material (Comparative Example 5).

In particular, it can be found that in Comparative Example 1 including the secondary-particle positive electrode active material, although milling was carried out both before and after annealing, the capacity retention rate was very reduced.

Although descriptions have been made above with reference to Examples of the present disclosure, it will be understood by those skilled in the relevant technical field or those having ordinary knowledge in the relevant technical field that various modifications and changes can be made to various examples of the present disclosure within a scope that does not depart from the technical area of various examples of the present disclosure described in the claims described below. Therefore, the technical scope of various examples of the present disclosure should not be limited to the contents described in the detailed description of the specification, but should be defined by the claims.

What is claimed is:

1. A positive electrode active material comprising at least one type selected from a lithium nickel oxide (LNO)-based positive electrode active material, a nickel-cobalt-manganese (NCM)-based positive electrode active material, a nickel-cobalt-aluminum (NCA)-based positive electrode active material and a nickel-cobalt-manganese-aluminum (NCMA)-based positive electrode active material,
wherein:
the positive electrode active material contains single particles,
a content of F is about 5,700 mg/kg to 6,500 mg/kg, and/or
an a-axis lattice parameter of the positive electrode active material measured by an X-ray diffraction (XRD) analysis is about 2.8753 Å to 2.8772 Å, a c-axis lattice parameter of the positive electrode active material is about 14.243 Å to 14.255 Å, a cell volume of the positive electrode active material is about 101.968 Å³ to 102.168 Å³ and a crystallite size of the positive electrode active material is greater than about 130 nm and equal to or less than 136 nm.

2. The positive electrode active material according to claim 1, wherein the positive electrode active material contains 40 mol % or more of Ni based on 100 mol % of all remaining metals excluding Li.

3. The positive electrode active material according to claim 1, wherein the positive electrode active material has a surface coated with a coating agent containing metal or carbon.

4. The positive electrode active material according to claim 1, wherein the positive electrode active material is a recycled positive electrode active material.

5. A positive electrode active material recycling method comprising:
(a) performing heat treatment of a waste positive electrode having a positive electrode active material layer formed on a current collector at about 300° C. to 650° C. so as to thermally decompose a binder and a conductive material in the positive electrode active material layer and to recover a single-particle-containing positive electrode active material in the positive electrode active material layer;
(b) adding a lithium precursor to the recovered positive electrode active material and annealing the positive electrode active material at about 400° C. to 1,000° C.;
(c) washing the annealed positive electrode active material with a washing solution; and
(d) performing surface-coating of the washed positive electrode active material,
wherein the positive electrode active material recycling method includes:
performing milling before the recovered positive electrode active material is annealed in (b); and/or
performing the milling before the annealed positive electrode active material is washed in (c).

6. A positive electrode active material recycling method comprising:
(a) performing heat treatment of a waste positive electrode having a mid-nickel positive electrode active material layer formed on a current collector at about 300° C. to 650° C. so as to thermally decompose a binder and a conductive material in the positive electrode active material layer and to recover a single-particle-containing positive electrode active material in the positive electrode active material layer;
(b) adding a lithium precursor to the recovered positive electrode active material and annealing the positive electrode active material at 400° C. to 1,000° C.;
(c) washing the annealed positive electrode active material with a washing solution; and
(d) performing surface-coating of the washed positive electrode active material,
wherein the positive electrode active material recycling method includes:
performing milling before the recovered positive electrode active material is annealed in (b); and/or
performing the milling before the annealed positive electrode active material is washed in (c).

7. The positive electrode active material recycling method according to claim 5, wherein the positive electrode active material layer is at least one type selected from a lithium nickel oxide (LNO)-based positive electrode active material, a nickel-cobalt-manganese (NCM)-based positive electrode active material, a nickel-cobalt-aluminum (NCA)-based positive electrode active material, and a nickel-cobalt-manganese-aluminum (NCMA)-based positive electrode active material, and contains 40 mol % or more of Ni based on 100 mol % of all remaining metals excluding Li.

8. The positive electrode active material recycling method according to claim 5, wherein the milling is carried out by using a centrifugal mill, a jet mill, or a pin mill.

9. The positive electrode active material recycling method according to claim 5, wherein the milling is carried out at about 6,000 rpm to 18,000 rpm.

10. The positive electrode active material recycling method according to claim 5, wherein the lithium precursor contains at least one of LiOH, Li₂CO₃, LiNO₃, and Li₂O.

11. The positive electrode active material recycling method according to claim 5, wherein in (b), the lithium precursor is added at least in an amount reduced from a molar ratio of lithium in the positive electrode active material in (a) on the basis of the amount of lithium in the recovered positive electrode active material.

12. The positive electrode active material recycling method according to claim 5, wherein in the washing in (c), a weight ratio of the annealed positive electrode active material or the milled positive electrode active material to the washing solution is about 1:0.5 to 1:5.5.

13. The positive electrode active material recycling method according to claim 5, wherein the washing in (c) includes mixing the annealed positive electrode active material or the milled positive electrode active material with the washing solution and performing filtration; and
drying a solid positive electrode active material obtained after the filtration.

14. The positive electrode active material recycling method according to claim 5, wherein in the surface-coating of (d), a surface is coated with at least one type of a metal, an organic metal, and a carbon component in a solid or liquid manner and then heat treatment is performed at about 100° C. to 1,200° C.
